(19) United States
(12) Patent Application Publication
(10) Pub. No.: US 2025/0368396 A1
(43) Pub. Date: Dec. 4, 2025

(54) BAG ASSEMBLY HAVING A FRONT PANEL ZIPPER ASSEMBLY AND TEAR STRIP

(71) Applicant: Illinois Tool Works Inc., Glenview, IL (US)

(72) Inventors: Jose Manuel Septien Rojas, Naperville, IL (US); Eric P. Plourde, Frankfort, IL (US); David J. Matthews, Gilman, IL (US); Clifton R. Howell, White, GA (US)

(73) Assignee: Illinois Tool Works Inc., Glenview, IL (US)

(21) Appl. No.: 19/195,143

(22) Filed: Apr. 30, 2025

Related U.S. Application Data
(60) Provisional application No. 63/655,469, filed on Jun. 3, 2024.

(51) Int. Cl. B65D 33/25; B31B 70/81; B31B 155/00; B65D 75/58

(52) U.S. Cl. CPC B65D 33/2508; B31B 70/8131; B65D 75/5844; B31B 2155/00; B65D 2575/586

(57) ABSTRACT

A resealable bag assembly can include a zipper assembly between front and rear panels. The zipper assembly can include interlocking bodies that can be repeatedly opened and closed to repeatedly open and close the interior volume. The bag assembly may include a tear strip having an elongated cord that can be grasped through the tab opening in the front panel and pulled to tear an access opening through the front panel for accessing the zipper assembly. The bag assembly may include a racetrack seal between the front flange of the zipper assembly and the front panel. The racetrack seal can completely encircle the tab opening. The racetrack seal can prevent air or a contaminant from passing from outside the front and rear panels into the interior volume via the tab opening while the zipper assembly is closed.

### CROSS-REFERENCE TO RELATED APPLICATIONS

This application claims priority to U.S. Provisional Application No. 63/655,469 (filed 3 Jun. 2024), the entire disclosure of which is incorporated herein by reference.

### BACKGROUND

### Technical Field

The subject matter described herein relates to bag assemblies having zippers inside the bag assemblies along the front panels of the bag assemblies, and tear strips used to tear openings into the bag assemblies for accessing the zipper assemblies.

### Discussion of Art

Some known bag assemblies or pouches can have front-panel openings with press-to-close reclosable zippers. These bag assemblies can have the zippers coupled to inside surfaces of panels of the bag assemblies. The panels of the bag assemblies may be sealed together above the zipper assemblies so that consumers or users cannot access the zippers inside the bag assemblies. Tear strips may be disposed inside the bag assemblies above the zipper assemblies. The tear strips can be adhered to the zipper assemblies. The tear strips are grasped and pulled to tear openings into the bag assemblies. Users or consumers can reach into the bag assemblies through these tear strip openings to reach the zipper assemblies. The users or consumers can then pull apart the zipper assemblies to access the contents inside the bag assemblies (e.g., below the zipper assemblies).

Some of these bag assemblies, however, may not be hermetically sealed, especially ones having tear strips that are exposed on the outside of the bag assemblies. For example, a hole may be punched through at least the front wall of a bag assembly so that a consumer or user can see and grasp the tear strip. This hole, however, may provide an ingress path for air or other materials to enter into the inside of the bag assembly. The air or other materials can contaminate contents inside the bag assembly, can increase the rate of spoilation of the contents inside the bag assembly, can accelerate oxidation of the contents in the bag assembly, can promote drying out of the contents in the bag assembly, can contribute to degradation of the contents inside the bag assembly, or can reduce the shelf life of the contents in the bag assembly.

A need may exist for a bag assembly having an exposed tear strip that decreases or eliminates the shortcomings described above.

### BRIEF DESCRIPTION

One example of a resealable bag assembly includes opposing front and rear panels joined with each other to define an interior volume. The front panel can include a tab opening. The bag assembly also can include a zipper assembly between the front and rear panels and having front and rear flanges. The front flange can be coupled with the front panel. The rear flange can be coupled with the rear panel or the front panel (e.g., with both the front and rear flanges coupled with the front panel in different locations along an inside surface of the front panel, such as with the rear flange attached to the front panel above the front flange). The zipper assembly can include interlocking bodies that can be repeatedly opened and closed to repeatedly open and close the interior volume. The bag assembly may include a tear strip having an elongated cord that can be grasped through the tab opening in the front panel and pulled to tear an access opening through the front panel for accessing the zipper assembly. The bag assembly may include a racetrack seal between the front flange of the zipper assembly and the front panel. The racetrack seal can completely encircle the tab opening (e.g., such that there are no gaps in the racetrack seal around the tab opening). The racetrack seal can prevent air or a contaminant from passing from outside the front and rear panels into the interior volume via the tab opening while the zipper assembly is closed.

One example of a method (e.g., for forming a bag assembly) includes applying a zipper assembly and a tear strip to a flat web of material with a set of seals. The zipper assembly can have front and rear flanges with interlocking bodies configured to be repeatedly separated and coupled with each other. The method also can include forming a bag assembly that is closed along four sides with the zipper assembly and a tear strip located inside the bag assembly. The bag assembly can include a tab opening through which the tear strip is grasped and pulled to tear an access opening through the web of material to access the zipper assembly. The set of seals can form at least one racetrack seal between the zipper assembly and the web of material that completely encircles the tab opening.

One example of a resealable bag assembly includes posing front and rear panels joined with each other along opposite top and bottom edges and opposite left and right edges to define an interior volume. The front panel can include a tab opening. The bag assembly also can include a zipper assembly coupled with the front and rear panels or just the front panel. The zipper assembly can be repeatedly opened and closed to repeatedly open and close the interior volume. The bag assembly can include a tear strip configured to be grasped through the tab opening in the front panel and pulled to tear an access opening through the front panel for accessing the zipper assembly. The bag assembly can include a continuous annular racetrack seal between the front flange of the zipper assembly and the front panel. The racetrack seal can completely encircle (e.g., surround the outer perimeter of) the tab opening and seal the zipper assembly to the front panel.

### BRIEF DESCRIPTION OF THE DRAWINGS

The inventive subject matter may be understood from reading the following description of non-limiting embodiments, with reference to the attached drawings, wherein below:

FIG. 1 illustrates one example of a bag assembly;

FIG. 2 illustrates a cross-sectional view of a top portion of the bag assembly along line A-A shown in FIG. 1;

FIG. 3 illustrates a cross-sectional view of one example of a zipper assembly shown in FIG. 2 along line A-A in FIG. 1;

FIG. 4 illustrates a cross-sectional view of another example of the zipper assembly along line A-A shown in FIG. 1;

FIG. 5 illustrates another example of the bag assembly;

FIG. 6 illustrates one example of an opening in a front flange of the zipper assembly to create a tab of the tear strip;

FIG. 7 illustrates another example of the opening in the front flange to create the tab of the tear strip;

FIG. 8 illustrates a front view of another example of a top portion of the bag assembly shown in FIG. 1;

FIG. 9 illustrates a cross-sectional view of the bag assembly along line 9-9 in FIG. 8;

FIG. 10 illustrates one example of an initiation aid hole through a back panel of the bag assembly; and

FIG. 11 illustrates one example of initiation aid slits through front panel of the bag assembly.

### DETAILED DESCRIPTION

Many existing bag assemblies or pouches are designed with press-to-close reclosable zippers that allow users to reseal the bags after opening. These bag assemblies often include zippers coupled to the inside surfaces of the panels, with the panels sealed together above the zipper assemblies to prevent immediate access. To facilitate opening, some bag assemblies incorporate tear strips positioned inside the bag, above the zipper assembly. These tear strips are typically adhered to the zipper assembly and are accessed by pulling on a tab or cord to create an opening in the bag. Once the tear strip is removed, users can access the zipper assembly to open and reseal the bag.

However, many of these bag assemblies suffer from drawbacks. In particular, some designs require a hole to be punched through the front panel of the bag to allow users to see and grasp the tear strip. This hole, while functional, creates a potential ingress point for air, moisture, or contaminants to enter the bag. Such exposure can compromise the contents of the bag, leading to contamination, spoilage, oxidation, or drying out of the stored product. These issues can degrade the quality of the contents and reduce their shelf life. Additionally, the lack of a hermetic seal in some designs further exacerbates these problems, as air and contaminants can pass through gaps in the zipper assembly or other unsealed areas.

The subject matter described herein addresses these shortcomings by providing a resealable bag assembly that incorporates a novel configuration to ensure both functionality and enhanced protection of the bag's contents. The described assembly includes a zipper mechanism positioned between opposing front and rear panels, with interlocking bodies that can be repeatedly opened and closed. A tear strip is provided to facilitate access to the zipper mechanism, and a specialized sealing arrangement is employed to prevent air or contaminants from entering the bag through the tab opening or other potential ingress points. This design ensures that the bag assembly maintains a hermetic seal while still allowing users to access and reseal the bag with ease.

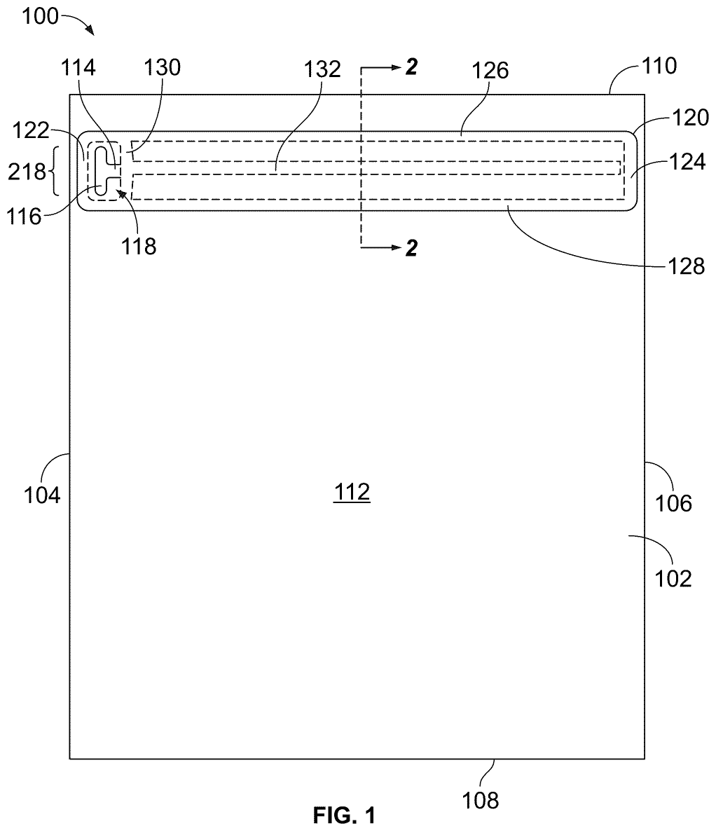

FIG. 1 illustrates one example of a bag assembly 100. The bag assembly 100 includes a front panel 102 coupled with a back panel (not visible in FIG. 1) along at least opposite sides, edges, or interfaces 104, 106, and along a bottom side, edge, or interface 108. A top side, edge, or interface 110 of the bag assembly 100 may be closed. For example, the top edge 110 may be closed with the front and back panels coupled with each other along the top edge 110.

The bag assembly 100 may include gusseted sides between the front panel 102 and the back panel. For example, additional side panel may extend from the front panel 102 to the back panel along one or both the side edges or interfaces 104, 106. The bag assembly 100 can be a pillow bag, a stand-up pouch (e.g., a bag having a wider surface along the bottom interface 108 to allow the bag to stand upright on its own), or a gusseted pouch. The panels of the bag assembly 100 enclose an interior volume 112 of the bag assembly 100 in which a product can be stored.

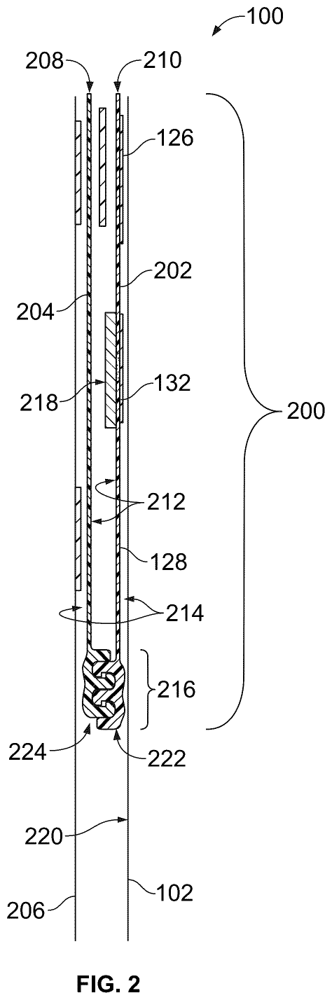

With continued reference to the bag assembly 100 shown in FIG. 1, FIG. 2 illustrates a cross-sectional view of a top portion of the bag assembly 100 along line A-A shown in FIG. 1. The bag assembly 100 may include a zipper assembly 200 that can be used to repeatedly open and re-seal (or close) the bag assembly 100. The zipper assembly 200 includes opposing flanges 202, 204 that may both be coupled with the front panel or wall 102 of the bag assembly 100. For example, the back flange 204 may extend higher than the front flange 202 such that a top edge 208 of the back flange 204 is closer to the top edge 110 of the bag assembly 100 than a top edge 210 of the front flange 202. Alternatively, the front flange 202 may extend higher than the back flange 204, or both the front and back flanges 202, 204 may extend to the same height. In another example, the front flange 202 may be coupled (e.g., sealed) with the front panel 102 and the back flange 204 may be coupled (e.g., sealed) with the back panel 206 of the bag assembly 100, without the back flange 204 being coupled with the front panel 102 or the front flange 202 being coupled with the back panel 206.

Each flange 202, 204 may have a facing or internal surface 212 and an opposite or exterior surface 214. The facing surfaces 212 of the flanges 202, 204 may face each other and may face the other flange 202 or 204, while the exterior surfaces 214 face away from each other and away from both flanges 202, 204. The facing surfaces 212 of the flanges 202, 204 may include locking or interlocking elements 216 that mate with each other to seal the bag assembly 100 closed and that can be separated from each other to open the bag assembly 100. These interlocking elements 216 can be repeatedly mated and separated to repeatedly open and close the bag assembly 100. When mated, the interlocking elements 216 may seal off the interior volume of the bag assembly 100 from the atmosphere outside the bag assembly 100. In one example, the interlocking elements 216 include curved bodies that partially wrap around each other to seal the interior volume of the bag assembly 100 closed. The interlocking elements 216 allow the bag assembly 100 to repeatedly open and close, thereby providing a recloseable or resealable bag assembly 100.

A tear strip 218 may be positioned between the flanges 202, 204. This tear strip 218 can have an elongated body 114 coupled with a wider head or tab 116. The head or tab 116 can be formed from the same material as the front flange 202. For example, The head or tab 116 may be bonded to the body 114 of the tear strip 218, but cut from the front flange material. An opening 118 may be cut through the front flange 202 to form the tab 116 and the opening 118, with the tab 116 remaining connected to the body 114. The opening 118 also provides exterior access to the tab 116. The opening 118 does not extend through the back flange 204 in at least one embodiment. For example, the front flange 202, but not the back flange 204, may be cut to remove an area of the front flange 202 between the border of the opening 118 and the border of the tab 116. Optionally, the tab 116 may include additional material that is bonded to the elongated body 114 to provide a larger body for a user to grasp.

The body 114 of the tear strip 218 may be formed from a material that is stiffer and/or tougher than the material used to form the panels 102, 206. For example, the panels 102, 206 may be formed from low density polyethylene, while the body 114 of the tear strip 218 is formed from high density polyethylene, polypropylene, cyclic olefin copolymer, etc. A user or consumer can grasp the head 116 of the tear strip 218 via the opening 118 in the front panel 102 of the bag assembly 100, and pull the head 116 of the tear strip 218 (to the right in the perspective of FIG. 1) to cause the elongated body 114 of the tear strip 218 to tear through the front panel 102. This can create an opening for the user or consumer to reach inside the bag assembly 100 above the interlocking elements 216 of the zipper assembly 200. The user or consumer can then grasp the flanges 202, 204, and pull the flanges 202, 204 away from each other to separate the interlocking elements 216 and reach the interior volume of the bag assembly 100.

The interlocking elements 216 may not form a hermetic seal with each other. The opening 118 through the front panel 102 and around the tab 116 connected to the body 114 of the tear strip 218 can provide an ingress location for air or contaminants to pass into the interior volume of the bag assembly 100 via any gaps or space between the interlocking elements 216. A combination of seals may be provided to seal off any or all paths into the interior volume of the bag assembly 100.

For example, the exterior surface 214 of the front flange 202 may be sealed to the front panel or wall 102 of the bag assembly 100 with an outer racetrack seal 120. The outer racetrack seal 120 may form a closed loop around the tear strip 218 (or at least the head 116 of the tear strip 218) and the opening 118 in the front panel 102. The outer racetrack seal 120 may be a continuous band of a heat seal that permanently bonds or fuses the front flange 202 to an inside surface 220 of the front panel 102. The heat seal 120 may be formed by applying heat to permanently bond or fuse the front flange 202 to the front panel 102. This permanent bond or seal between the flange 202 and the front panel 102 may be stronger than the flange 202 and/or the front panel 102 such that, if the flange 202 and panel 102 are pulled apart, the flange 202 and/or panel 102 will tear before the heat seal 120 is broken or destroyed. The outer racetrack seal 120 may have a variety of shapes, such as an oval shape, a rectangular shape with rounded corners, a rectangular shape with right angle corners, or the like.

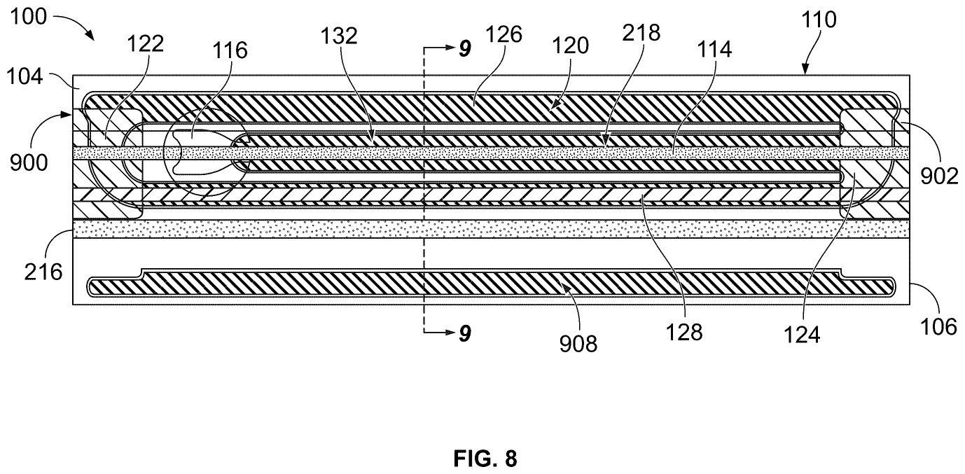

The outer racetrack seal 120 can be formed from different seals or sections, such as vertical seals or sections 122, 124 and horizontal seals or sections 126, 128. Each of the horizontal seals or sections 126, 128 may merge or intersect with each of the vertical seals or sections 122, 124, and each of the vertical seals or sections 122, 124 may merge or intersect with each of the horizontal seals or sections 126, 128. The vertical seal or section 122 may be between the tear strip 218 (e.g., the tab 116) and one side or edge 104 of the panels 102, 206 of the bag assembly 100. The vertical seal or section 124 may be between the tear strip 218 (e.g., the elongated body 114) and the other side or edge 106 of the panels 102, 206 of the bag assembly 100. The horizonal seal or section 126 may be between the tear strip 218 and the top side or edge 110 of the panels 102, 206 of the bag assembly 100. The horizontal seal or section 128 may be between the tear strip 218 and the interior of the bag assembly 100 or the bottom edge or side 108. As shown in FIG. 1, the entirety of both the elongated body 114 and the tab 116 of the tear strip 218 are located within the outer racetrack seal 220 such that all the elongated body 114 and the tab 116 are located between the horizontal seals or sections 126, 128 and between the vertical seals or sections 122, 124. Optionally, the elongated body 114 of the tear strip 218 may extend across the entire width of the bag assembly 100 (as shown in FIG. 8). For example, a series of bag assemblies 100 may be formed side-by-side with the zipper assemblies 200 for these bag assemblies 100 initially being in the form of a continuous zipper assembly that is then cut into segments corresponding to or associated with different bag assemblies 100 as the side edges 104, 106 are formed.

An additional vertical seal or section 130 may interconnect the horizontal seals 126, 128 between the vertical seals 122, 124. This additional vertical seal 130 can be referred to as an intermediate or middle vertical seal as the seal 130 is disposed between the seals 122, 124 and the seals 126, 128. The middle vertical seal 130 can intersect or merge with both the horizontal seals 126, 128 but may not intersect or merge with the other vertical seals 122, 124. The outer racetrack seal 120 may be formed from the horizontal seals 126, 128 and the outer vertical seals 122, 124. The vertical seal 122, the middle vertical seal 130, and the portions of the horizontal seals 126, 128 extending from one of the vertical seals 122, 130 to the other of the vertical seals 130, 122 may form another racetrack seal. This additional racetrack seal can be referred to as an inner racetrack seal as this racetrack seal is smaller than and is enclosed within the outer racetrack seal 120. These racetrack seals may share the vertical seal 122 and the portions of the horizontal seals 126, 128 extending from one of the vertical seals 122, 130 to the other of the vertical seals 130, 122.

An additional horizontal seal or section 132 may interconnect the outer vertical seals 122, 124 between the horizontal seals 126, 128. This additional horizontal seal 132 can be referred to as an intermediate or middle horizontal seal as the seal 132 is disposed between the seals 122, 124 and the seals 126, 128. The middle horizontal seal 132 can intersect or merge with the middle vertical seal 130 and extend from the middle vertical seal 124 toward the outer vertical seal 124, but not to the outer vertical seal 124. Alternatively, the middle horizontal seal 132 may extend from the vertical seal 130 to the vertical seal 124 and intersect both of these seals 130, 124. The middle horizontal seal 132 can be a heat seal that permanently bonds or fuses the elongated body 114 of the tear strip 218 to the front panel 102, as described above in connection with the racetrack seal 120.

The outer horizontal seal 126 may couple the front panel 102 with an upper part or portion of the front flange 202 (e.g., between the elongated body 114 of the tear strip 218 and the upper edge 210 of the front flange 202). The middle horizontal seal 132 can couple the elongated body 114 of the tear strip 218 to the front panel 102. The lower horizontal seal 128 may couple the front panel 102 with a lower part or portion of the front flange 202 (e.g., between the elongated body 114 of the tear strip 218 and the interlocking elements 216). The front flange 202 may include a lower edge 222 that is on or at an opposite edge of the front flange 202 than the upper edge 210. The interlocking elements 216 can be located between this lower edge 222 and the elongated body 114 of the tear strip 218).

Optionally, the front flange 202 may extend farther below the interlocking elements 216. For example, the interlocking elements 216 may be spaced apart from the lower edge 210 of the front flange 202 by an additional lower portion of the front flange 202. This additional lower portion may be sealed to the front panel 102 by the lower horizontal seal 128 or an additional horizontal seal that may be parallel to the horizontal seals 126, 128.

The vertical seals 122, 124, 130 can couple the front panel 102 to the exterior side 214 of the front flange 202 across three different areas defined by the shapes of the vertical seals 122, 124, 130. The outer vertical seal 122 may seal the front flange 202 to the front panel 102 in a location that is between the tab 116 of the tear strip 218 and the interface or edge 104 of the bag assembly 100. The outer vertical seal 124 can seal the front flange 202 to the front panel 102 in a location that is between an end of the elongated body 114 of the tear strip 218 and the other interface or edge 106 of the bag assembly 100. Optionally, the outer vertical seal 124 can extend across the elongated body 114 of the tear strip 218 such that the outer vertical seal 124 seals the front flange 202 and the elongated body 114 to the front panel 102. The back flange 204 can be sealed to the back panel 206 with one or more seals. This or these seals can be similar to or identical to one or more of the horizontal seals described herein.

Optionally, another horizontal seal may be positioned between the elongated body 114 of the tear strip 218 and the back flange 204. This seal may differ from the other heat seals described above in that the other heat seals may permanently bond or fuse the bodies being heat sealed together with heat seals that are not broken without tearing into, thinning, or otherwise damaging the panels 102, 206 and/or flanges 202, 240. In contrast, the additional horizontal seal between the elongated body 114 and the back flange 204 may be a heat sealable peel seal that can be broken by pulling the elongated body 114 away from the back flange 204. In contrast to the other seals, this pulling of the elongated body 114 separates the elongated body 114 from the back flange 204 without damaging or thinning the elongated body 114 or back flange 204. The heat sealable peel seal may differ from the permanent heat seals described herein in that the heat sealable peel seal may be weaker than the permanent heat seals and/or the bodies being coupled by the heat sealable peel seal. For example, it may require less force to destroy the heat sealable peel seal and separate the bodies joined by the heat sealable peel seal than the force(s) needed to tear the bodies or destroy the permanent heat seal.

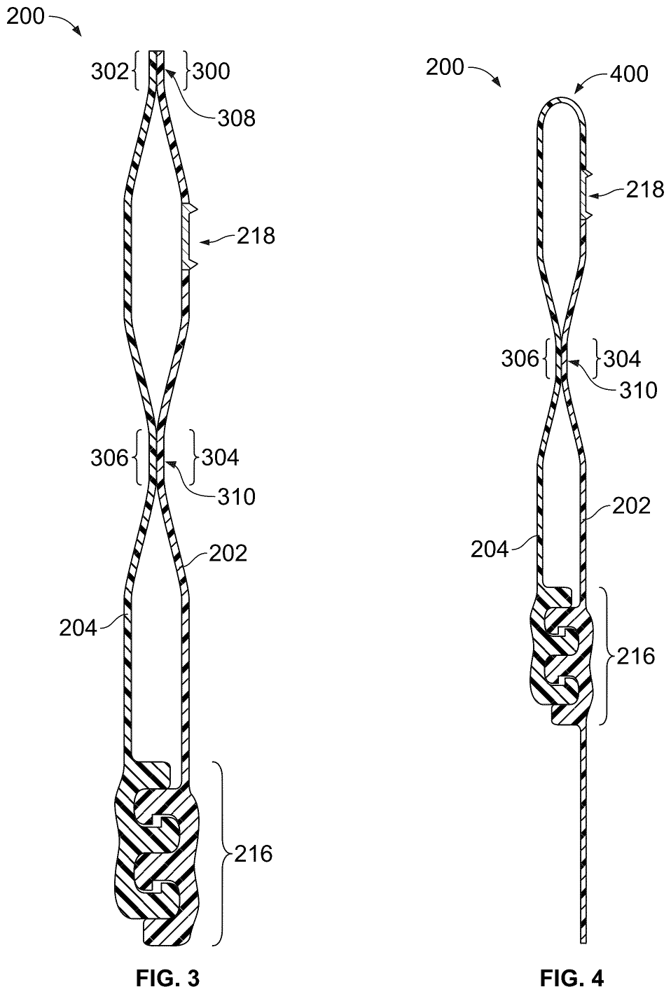

FIG. 3 illustrates a cross-sectional view of one example of the zipper assembly 200 along line A-A shown in FIG. 1. The front flange 202 and the back or rear flange 204 may be sealed to each other at or near the top edges 208, 210 of the flanges 204, 202. For example, a sealant used to create the horizontal seals and vertical seals described above (other than a peelable heat seal) may be used to create an upper flange seal 308 between upper portions 300, 302 of the front and rear flanges 202, 204. These upper portions 300, 302 may extend from the top edges 208, 210 toward, but not all the way to, the tear strip 218, as shown in FIG. 3. Optionally, the upper portions 300, 302 that are sealed together may extend from the top edges 208, 210 to, but not below, the tear strip 218. In another example, the upper sealed portions 300, 302 may be spaced apart from the top edges 208, 210 and the tear strip 218. In yet another example, the upper sealed portions 300, 302 may be spaced apart from the top edges 208, 210 but extend to the tear strip 218. Optionally, the portions 300, 302 of the flanges 202, 204 may be sealed to the panels 102, 206 of the bag assembly 100 and to each other when the panels 102, 206 are sealed together at or near the top edge or interface 110 of the bag assembly 100.

The front flange 202 and the back or rear flange 204 optionally may be sealed to each other at a lower flange seal 310 between the tear strip 218 and the interlocking elements 216. For example, a weaker seal than the horizontal and vertical seals (e.g., a peelable heat seal) may be used to seal lower portions 304, 306 of the front and rear flanges 202, 204 to each other at the lower flange seal 310. These lower portions 304, 306 may be located between the tear strip 218 and the interlocking elements 216. The lower portions 304, 306 may be spaced apart from and not extend to either the tear strip 218 or the interlocking elements 216. Optionally, the lower portions 304, 306 may extend to the tear strip 218 and/or the interlocking elements 216. The seal 310 between lower portions 304, 306 may provide additional protection against air or contaminants from passing through the opening 118 and into the interior volume of the bag assembly 100. Once a user uses the tear strip 218 to access the lower flange seal 310, the user can pull the flanges 202, 204 apart to break this lower flange seal 310 and access the interior volume of the bag assembly 100. Optionally, an additional peel seal (e.g., a heat sealable peel seal) may be between and may couple the flanges 202, 204 below the interlocking elements 216 (e.g., in areas between the interior volume and the interlocking elements 216). This additional peel seal may extend across the entire width of the flanges 202, 204 and/or bag assembly 100 to provide an additional seal to protect the product inside the bag assembly 100.

FIG. 4 illustrates a cross-sectional view of another example of the zipper assembly 200 along line A-A shown in FIG. 1. The front flange 202 and the back or rear flange 204 may be different parts or segments of a continuous flange. This continuous flange may include a bend 400. This bend 400 can be where the continuous flange is folded to form the front flange 202 and the back flange 204 without any gap in the material forming the flanges 202, 204 between the flanges 202, 204. The front flange 202 may extend from the bend 400 to the lower edge 222 and the back flange 204 may extend from the bend 400 to a lower edge 224 of the back flange 204. The flanges 202, 204 also can be sealed together between the tear strip 218 and the interlocking elements 216 by the lower flange seal 310.

The sealing of the tops of the flanges 202, 204 to each other, usage of the continuous flange with the bend 400, or sealing the tops of the flanges 202, 204 to each other and the front and rear panels 102, 206 can seal off the top side of the bag assembly 100 and the zipper assembly 200. A combination or the set of the outer vertical seal 122, the middle vertical seal 130, the portion of the upper horizontal seal 126 that extends from the seal 122 to the seal 130, and the portion of the lower horizontal seal 128 that extends from the seal 122 to the seal 130 frame or encircle the opening 118 in the front panel 102. This can prevent air or contaminants that are outside the bag assembly 100 from passing into the interior volume of the bag assembly 100 via the opening 118 and space between the interlocking elements 216. While air or contaminants may enter the opening 118, this combination or set of seals 122, 130, 126, 128 prevents the air or contaminants from passing further into the bag assembly 100.

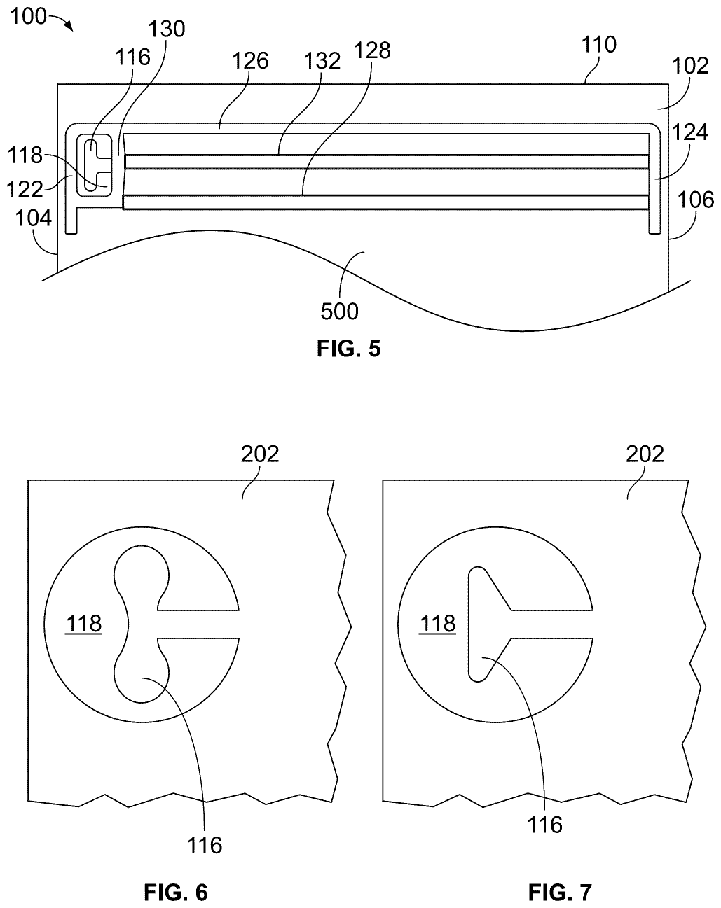

FIG. 5 illustrates another example of the bag assembly 100. The bag assembly 100 may include the panels 102, 206, zipper assembly 200, and tear strip 218 described above. This can include the horizontal seals 126, 128, 132 and the vertical seals 122, 124, 130 described above. One difference between the bag assemblies 100 shown in FIGS. 1 and 5 is that the bag assembly 100 in FIG. 5 can include an additional horizontal seal 500.

The outer vertical seals 122, 124 can extend from the upper horizontal seal 126 to the additional lower horizontal seal 500. The middle vertical seal 130 can extend from the upper horizontal seal 126 to the lower horizontal seal 128, but not to the additional lower horizontal seal 500. Optionally, the middle vertical seal 130 can extend to the lower horizontal seal 500. This lower horizontal seal 500 can couple the front flange 202 to the front panel 102 in an additional location for additional protection against air and contaminants reaching the interior volume of the bag assembly 100.

FIG. 6 illustrates one example of the opening 118 in the front flange 202 to create the tab 116 of the tear strip 218. FIG. 7 illustrates another example of the opening 118 in the front flange 202 to create the tab 116 of the tear strip 218. The front flange 202 can be cut to have a two-dimensional section or area of the front flange 202 removed. This removed area corresponds to the opening 118. For example, the shape that is cut through the front flange 202 to remove the area of the front flange 202 forms the opening 118 of the same shape. This also can form the tab 116 of the tear strip 218. For example, the part of the flange 202 that is left remaining after cutting the opening 118 can form the tab 116. The elongated body 114 can be sealed to this tab 116 using a sealant or adhesive that will not separate the tab 116 from the body 114 when pulled. The shape of the tab 116 that is formed may be the same as or vary from the examples shown herein. For example, the tab 116 may have a round shape (e.g., a circular or oval shape), a polygon shape, or the like. The front flange 202 and back flange 204 may be colored differently so that the tab 116 is more visibly apparent (relative to the front and back flanges 202, 204 being the same color). For example, the back flange 204 may be red and the front flange 202 may be white, thereby resulting in a white tab 116 on top of a red background provided by the back flange 204. Optionally, the middle horizontal seal 132 may be extruded with the back flange 204 and be colored differently than the front flange 202 to help make the tab 116 more visibly apparent.

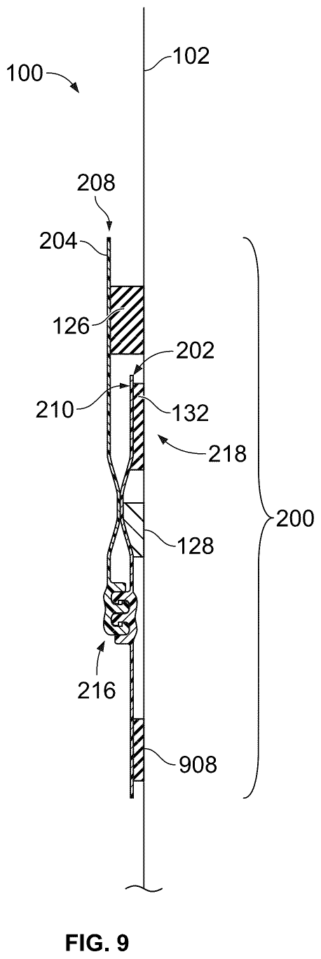

FIG. 8 illustrates a front view of another example of a top portion of the bag assembly 100 shown in FIG. 1. FIG. 9 illustrates a cross-sectional view of the bag assembly 100 along line 9-9 in FIG. 8. As described above, the bag assembly 100 can include the zipper assembly 200 with the tear strip 218 having the tab 116 and elongated body 114 (also referred to as a tear cord or strip). The zipper assembly 200 also includes the front and rear flanges 202, 204, and the interlocking bodies 216.

In the illustrated example, the rear flange 204 is taller than the front flange 202. The top edge 208 of the rear flange 204 can be closer to the top edge or interface 110 of the bag assembly 100 than the top edge 210 of the front flange 202. Optionally, the front and rear flanges 202, 204 may be the same height with the top edges 208, 210 of the flanges 204, 202 being the same distance from the top edge or interface 110 of the bag assembly 100.

As described above, the bag assembly 100 may include a racetrack seal 120 formed by the upper horizontal seal 126, the lower horizontal seal 128, and the outer vertical seals 122, 124. The middle horizontal seal 132 may couple the tear strip 218 with the front panel 102. In the illustrated example, however, the middle vertical seal 130 may not be provided.

The middle horizontal seal 132 may be larger than the elongated body 114 of the tear strip 218. For example, the middle horizontal seal 132 may be wider than the elongated body 114 in a direction that is perpendicular to the direction of the longest lengths of the seal 132 and body 114. The upper horizontal seal 126 can couple the back flange 204 to the front panel 102, as shown in FIG. 9.

The flanges 202, 204 can be deformed by crushing the flanges 202, 204 inside areas 900, 902 along the opposite interfaces 104, 106 of the bag assembly 100. These areas also may be sealed to each other. This can occur before the zipper assembly 200 is sealed to the inside surfaces of the panels 102, 206. An additional horizontal seal 906 can be provided along the lower horizontal seal 128. This may be a peel seal material that is easier to break than the lower horizontal seal 128. An additional horizontal seal 908 (also referred to as a carrier seal) may be between and couple the lower portion of the flange 202 (e.g., the portion that is below the interlocking elements 216) and the front panel 102. These seals can ensure that air or contaminants are prevented from reaching the interior of the bag assembly 100.

The presence of the flanges 202, 204 above and below the tear strip 218 with the flanges 202, 204 sealed to the panels 102, 206 above and below the tear strip 218 can provide a shear for a user to tear or pull against when using the tear strip 218 to form an opening through the front panel 102.

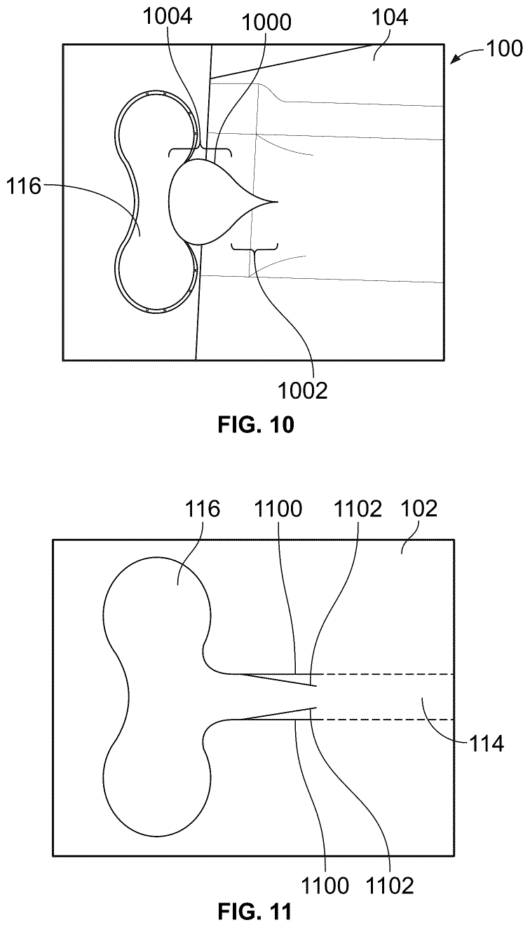

FIG. 10 illustrates one example of an initiation aid hole 1000 through the back panel 206 of the bag assembly 100. The hole 1000 can represent an area of the back panel 206 that is cut away and discarded. Optionally, the hole 1000 can be cut through the back flange 204 in addition to the back panel 206. The hole 1000 can be formed using a punch or other cutting tool. The hole 1000 can be cut to narrow or dovetail to a narrow segment 1002 from a larger segment 1004. The narrow segment 1002 may have the shape of the letter V in the illustrated example, but may have another shape (e.g., the shape of the letter U). The hole 1000 can be formed behind the tear strip 218 and extend over the location where the contact between the tear strip 218 and the middle horizontal seal 132 begins.

This hole 1000 can aid in separation of the tear strip 218 from the back flange 204. For example, the tear strip 218 may require less force to be peeled away from the back flange 204 when first pulled relative to the hole 1000 not being present. The force required to initially separate the tear strip 218 from the back flange 204 may be smaller and gradually increase as the tear strip 218 is pulled due to the hole 1000 reducing the required pulling force to initiate separation of the tear strip 218 from the back flange 204.

FIG. 11 illustrates one example of initiation aid slits 1100, 1102 through the front panel 102 of the bag assembly 100. The slits 1100, 1102 can be linear or curved cuts through the front panel 102. Optionally, the front panel 102 may include the slits 1100 but not the slits 1102, or may include the slits 1102 but not the slits 1100. The slits 1100, 1102 can be formed during extrusion of the front panel 102, or may be cut using a tool having a sharp blade.

The slits 1100 can be parallel to each other and be on opposite sides of the elongated body 114 of the tear strip 218. The slits 1102 can be transverse to each other by following dovetail or intersecting paths. For example, the slits 1102 may have ends closer to the tab 116 that are farther from each other than the opposite ends of the slits that are farther from the tab 116.

As the tab 116 of the tear strip 218 is pulled, the tearing of the front panel 102 by the elongated body 114 of the tear strip 218 may initially extend from the ends of the slits 1100, 1102. The slits 1100, 1102 can guide the directions in which the front panel 102 is cut or torn by the elongated body 114. For example, the slits 1100 can ensure that the elongated body 114 tears the front panel 102 on either side of the elongated body 114 instead of tearing the front panel 102 in one or more directions that are angled (e.g., transverse) to the length direction of the elongated body 114. For example, the slits 1102 can ensure that the elongated body 114 tears the front panel 102 over or along the path of the elongated body 114 of the tear strip 218 instead of tearing the front panel 102 in one or more directions that are angled (e.g., transverse) relative to and oriented away from the length direction of the elongated body 114.

Angled tears through the front panel 102 in directions that extend away from the tear strip 218 can cause the hole formed through the front panel 102 by the tear strip 218 to not be wide enough to allow a user to access the zipper assembly 200 and/or can cause the tear strip 218 to tear part of the front flange 202. A tear through the front flange 202 may end up creating a hole through which air or contaminants can reach the interior of the bag assembly 100 even after the interlocking elements 216 are interlocked.

A method for providing one or more of the bag assemblies described herein can include applying the zipper assembly to a flat web of the material from which the panels are formed. The zipper assembly can be applied by applying heat and pressure to form heat seals in locations for the seals described herein between the zipper assembly and the web. Optionally, these seals can include an adhesive placed between the bodies being coupled by the seals. This web can then be rolled up in a Vertical Form Fill Seal (VFFS) machine. The VFFS machine can form a tube with the web. Product may be placed into the tube-shaped web. The top and/or bottom edges of the tube can be sealed together to form the top and bottom interfaces of the bag assembly. The tube can be at least partially flattened with the sides or interfaces 104, 106 formed by folds in the tube that extend from the top interface to the bottom interface. Because the zipper assembly has already been applied to the web, the zipper assembly need not be applied to the web at or in the VFFS machine. Having the zipper assembly attached only to the front panel 102 can allow the contents inside the bag assembly 100 to be easily filled through the top of the bag assembly 100 prior to sealing the top of the bag assembly. This can be helpful for pre-made pouches that are filled on a fill-seal machine.

One example of a resealable bag assembly may include opposing front and rear panels joined with each other to define an interior volume. The front panel can include a tab opening. The bag assembly also can include a zipper assembly between the front and rear panels and having front and rear flanges. The front flange can be coupled with the front panel. The rear flange can be coupled with the rear panel or the front panel (e.g., with both the front and rear flanges coupled with the front panel in different locations along an inside surface of the front panel, such as with the rear flange attached to the front panel above the front flange). The zipper assembly can include interlocking bodies that can be repeatedly opened and closed to repeatedly open and close the interior volume. The bag assembly may include a tear strip having an elongated cord that can be grasped through the tab opening in the front panel and pulled to tear an access opening through the front panel for accessing the zipper assembly. The bag assembly may include a racetrack seal between the front flange of the zipper assembly and the front panel. The racetrack seal can completely encircle the tab opening (e.g., such that there are no gaps in the racetrack seal around the tab opening). The racetrack seal can prevent air or contaminants from passing from outside the front and rear panels into the interior volume via the tab opening while the zipper assembly is closed.

The tear strip can include a tab connected to the elongated cord and disposed within the tab opening. The tab can be grasped and pulled to tear the elongated cord through the front panel. The racetrack seal can be a continuous annular seal.

The racetrack seal may be an inner racetrack seal, and the bag assembly may also include an outer racetrack seal that is partially coextensive with the inner racetrack seal (e.g., the outer and inner racetrack seals may share at least one portion of a seal or otherwise overlap each other). The outer racetrack seal can be formed from a continuous annular seal that is outside of the inner racetrack seal. The outer racetrack seal can be formed by an upper horizontal seal located between the elongated cord of the tear strip and a top edge of the front and rear panels, a lower horizontal seal located between the elongated cord and the interlocking bodies, a first vertical seal between the tab opening and a first side edge of the first and second panels, and a second vertical seal between the tab opening and a second side edge of the first and second panels that is opposite the first side edge.

The inner racetrack seal may be formed by a middle vertical seal disposed between the second vertical seal of the outer racetrack seal and the tab opening, the first vertical seal, a first portion of the upper horizontal seal that extends from the first vertical seal to the middle vertical seal, and a second portion of the lower horizontal seal that extends from the first vertical seal to the middle vertical seal. The bag assembly also can include a middle horizontal seal located between the elongated cord of the tear strip and the front panel and located between the upper and lower horizontal seals. The lower horizontal seal can be a first lower horizontal seal, and the bag assembly also can include a second lower horizontal seal located between the first lower horizontal seal and the interlocking bodies of the zipper assembly.

The front flange and the rear flange of the zipper assembly can be sealed together by an upper flange seal and a lower flange seal with the tear strip located between the upper flange seal and the lower flange seal, and the lower flange seal located between the tear strip and the interlocking bodies. The front flange and the rear flange can be different portions of a continuous flange having a bend with the front flange on a first side of the bend and the rear flange on a second side of the bend. The front flange and the rear flange can be sealed together by a flange seal located between the tear strip and the interlocking bodies. The tear strip can be located between the bend and the flange seal.

The tab can be part of the front flange that is at least partially surrounded by the tab opening. The rear flange can include a tear initiation opening extending through the rear flange at an interface between the tab and the elongated cord of the tear strip. The tear initiation opening in the rear flange can have a dovetail shape pointing along a length of the elongated cord of the tear strip.

The front panel can include tear initiation slits positioned to initiate tearing of the front panel in one or more directions along a length of the elongated cord of the tear strip. The slits can be on opposite sides of the elongated cord of the tear strip. The slits can be oriented toward each other and the elongated cord of the tear strip.

One example of a method (e.g., for forming a bag assembly) can include applying a zipper assembly and a tear strip to a flat web of material with a set of seals. The zipper assembly can have front and rear flanges with interlocking bodies configured to be repeatedly separated and coupled with each other. The method also can include forming a bag assembly that is closed along four sides with the zipper assembly and a tear strip located inside the bag assembly. The bag assembly can include a tab opening through which the tear strip is grasped and pulled to tear an access opening through the web of material to access the zipper assembly. The set of seals can form at least one racetrack seal between the zipper assembly and the web of material that completely encircles the tab opening.

One example of a resealable bag assembly can include posing front and rear panels joined with each other along opposite top and bottom edges and opposite left and right edges to define an interior volume. The front panel can include a tab opening. The bag assembly also can include a zipper assembly coupled with the front and rear panels or just the front panel. The zipper assembly can be repeatedly opened and closed to repeatedly open and close the interior volume. The bag assembly can include a tear strip configured to be grasped through the tab opening in the front panel and pulled to tear an access opening through the front panel for accessing the zipper assembly. The bag assembly can include a continuous annular racetrack seal between the front flange of the zipper assembly and the front panel. The racetrack seal can completely encircle (e.g., surround the outer perimeter of) the tab opening and seal the zipper assembly to the front panel.

The tear strip can be coupled with a tab that is part of the zipper assembly and that is disposed in the tab opening. The zipper assembly can include a front flange and a rear flange having interlocking bodies that repeatedly mate and separate from each other. The front flange and the rear flange can be sealed together by an upper flange seal and a lower flange seal with the tear strip located between the upper flange seal and the lower flange seal, and the lower flange seal located between the tear strip and the interlocking bodies.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A resealable bag assembly comprising:
opposing front and rear panels joined with each other to define an interior volume, the front panel including a tab opening;
a zipper assembly between the front and rear panels and having front and rear flanges, the front flange coupled with the front panel, the rear flange coupled with the rear panel or the front panel, the zipper assembly including interlocking bodies configured to be repeatedly opened and closed to repeatedly open and close the interior volume;
a tear strip including an elongated cord configured to be grasped through the tab opening in the front panel and pulled to tear an access opening through the front panel for accessing the zipper assembly; and
a racetrack seal between the front flange of the zipper assembly and the front panel, the racetrack seal completely encircling the tab opening, the racetrack seal preventing air or a contaminant from passing from outside the front and rear panels into the interior volume via the tab opening while the zipper assembly is closed.

2. The resealable bag assembly of claim 1, wherein the tear strip includes a tab connected to the elongated cord and disposed within the tab opening, the tab configured to be grasped and pulled to tear the elongated cord through the front panel.

3. The resealable bag assembly of claim 1, wherein the racetrack seal is a continuous annular seal.

4. The resealable bag assembly of claim 1, wherein the racetrack seal is an inner racetrack seal, and further comprising an outer racetrack seal that is partially coextensive with the inner racetrack seal, the outer racetrack seal formed from a continuous annular seal that is outside of the inner racetrack seal.

5. The resealable bag assembly of claim 4, wherein the outer racetrack seal is formed by an upper horizontal seal located between the elongated cord of the tear strip and a top edge of the front and rear panels, a lower horizontal seal located between the elongated cord and the interlocking bodies, a first vertical seal between the tab opening and a first side edge of the first and second panels, and a second vertical seal between the tab opening and a second side edge of the first and second panels that is opposite the first side edge.

6. The resealable bag assembly of claim 5, wherein the inner racetrack seal is formed by a middle vertical seal disposed between the second vertical seal of the outer racetrack seal and the tab opening, the first vertical seal, a first portion of the upper horizontal seal that extends from the first vertical seal to the middle vertical seal, and a second portion of the lower horizontal seal that extends from the first vertical seal to the middle vertical seal.

7. The resealable bag assembly of claim 5, further comprising a middle horizontal seal located between the elongated cord of the tear strip and the front panel and located between the upper and lower horizontal seals.

8. The resealable bag assembly of claim 5, wherein the lower horizontal seal is a first lower horizontal seal, and further comprising a second lower horizontal seal located between the first lower horizontal seal and the interlocking bodies of the zipper assembly.

9. The resealable bag assembly of claim 1, wherein the front flange and the rear flange of the zipper assembly are sealed together by an upper flange seal and a lower flange seal with the tear strip located between the upper flange seal and the lower flange seal, and the lower flange seal located between the tear strip and the interlocking bodies.

10. The resealable bag assembly of claim 1, wherein the front flange and the rear flange are different portions of a continuous flange having a bend with the front flange on a first side of the bend and the rear flange on a second side of the bend, the front flange and the rear flange are sealed together by a flange seal located between the tear strip and the interlocking bodies, the tear strip located between the bend and the flange seal.

11. The resealable bag assembly of claim 1, wherein the tab is part of the front flange that is at least partially surrounded by the tab opening.

12. The resealable bag assembly of claim 1, wherein the rear flange includes a tear initiation opening extending through the rear flange at an interface between the tab and the elongated cord of the tear strip.

13. The resealable bag assembly of claim 12, wherein the tear initiation opening in the rear flange has a dovetail shape pointing along a length of the elongated cord of the tear strip.

14. The resealable bag assembly of claim 1, wherein the front panel includes tear initiation slits positioned to initiate tearing of the front panel in one or more directions along a length of the elongated cord of the tear strip.

15. The resealable bag assembly of claim 14, wherein the slits are on opposite sides of the elongated cord of the tear strip.

16. The resealable bag assembly of claim 14, wherein the slits are oriented toward each other and the elongated cord of the tear strip.

17. A method comprising:
applying a zipper assembly and a tear strip to a flat web of material with a set of seals, the zipper assembly having front and rear flanges with interlocking bodies configured to be repeatedly separated and coupled with each other; and
forming a bag assembly that is closed along four sides with the zipper assembly and a tear strip located inside the bag assembly, the bag assembly including a tab opening through which the tear strip is grasped and pulled to tear an access opening through the web of material to access the zipper assembly, the set of seals forming at least one racetrack seal between the zipper assembly and the web of material that completely encircles the tab opening.

18. A resealable bag assembly comprising:
opposing front and rear panels joined with each other along opposite top and bottom edges and opposite left and right edges to define an interior volume, the front panel including a tab opening;
a zipper assembly coupled with the front and rear panels or just the front panel, the zipper assembly configured to be repeatedly opened and closed to repeatedly open and close the interior volume;
a tear strip configured to be grasped through the tab opening in the front panel and pulled to tear an access opening through the front panel for accessing the zipper assembly; and
a continuous annular racetrack seal between the front flange of the zipper assembly and the front panel, the racetrack seal completely encircling the tab opening and sealing the zipper assembly to the front panel.

19. The resealable bag assembly of claim 18, wherein the tear strip is coupled with a tab that is part of the zipper assembly and that is disposed in the tab opening.

20. The resealable bag assembly of claim 18, wherein the zipper assembly includes a front flange and a rear flange having interlocking bodies that repeatedly mate and separate from each other, the front flange and the rear flange sealed together by an upper flange seal and a lower flange seal with the tear strip located between the upper flange seal and the lower flange seal, and the lower flange seal located between the tear strip and the interlocking bodies.
